(19) United States
(12) Patent Application Publication
(10) Pub. No.: US 2011/0134483 A1
(43) Pub. Date: Jun. 9, 2011

(54) IMAGE PROCESSING APPARATUS, IMAGE PROCESSING METHOD, AND STORAGE MEDIUM

(75) Inventors: Osamu Iinuma, Machida-shi (JP); Reiji Misawa, Tokyo (JP)

(73) Assignee: CANON KABUSHIKI KAISHA, Tokyo (JP)

(21) Appl. No.: 12/954,183

(22) Filed: Nov. 24, 2010

(30) Foreign Application Priority Data
Dec. 8, 2009 (JP) 2009-278955

(51) Int. Cl. G06K 15/00

(52) U.S. Cl. 358/1.16

(57) ABSTRACT

An image processing apparatus for generating print data determines whether an occupancy rate of objects to be printed on a paper sheet is larger than a set threshold value, and, in a case where the occupancy rate is determined to be larger than the threshold value, performs processing for changing to the objects to reduce the occupancy rate thereof.

### BACKGROUND OF THE INVENTION

1. Field of the Invention

The present invention relates to an image processing apparatus which controls output of a filed electronic document, an image processing method, and a storage medium storing a computer program.

2. Description of the Related Art

Along with the increase in the use of digital image processing in recent copying machines, their functionality has been dramatically diversified. Copying machines nowadays are provided with diverse basic functions such as a copy function for copying a document, a page description language (PDL) printing function for printing PDL data (data described by the PDL) enabling printing a document generated by a host computer, a scanning function for scanning a document, and a sending function for sending a scanned document image via a network.

Many other functions provided by recent copying machines include a box function for storing image data generated by the copy function, the PDL printing function, and the scanning function in a storage unit (box) in the copying machine to enable reusing the image data, and an editing function for editing a document image.

Further, an electronic document filing technique attracts attention of the people. The technique stores a scanned document image in the storage unit in the copying machine or a server via a network to file the scanned document image. In electronic document filing, document images are electronically stored in a database so that a user can easily retrieve an electronic document and reuse the retrieved document.

On the other hand, reducing the amount of memory necessary for storing document data is one of major problems of electronic document filing. Japanese Patent Application Laid-Open No. 08-317155 discusses a technique including comparing an input scanned image data with an original document already filed, extracting additional information (added portions), and storing the additional information to the original document in a hierarchical structure, thus solving the above-mentioned problem.

Japanese Patent Application Laid-Open No. 08-317155 further discusses an example in which an original document to be compared with an input image data is identified by user specification, and another example in which, when an electronic document is scanned, a selection code such as a barcode printed thereon is recognized to identify the original document.

Japanese Patent Application Laid-Open No. 08-317155 further discusses an example in which, when information is added to a document B having previously added information, the newly added portion is extracted. Specifically, with the examples discussed in Japanese Patent Application Laid-Open No. 08-317155, each time information is added to an identical paper document, the added portion can be extracted.

Using the above-mentioned function for extracting and filing added portions (difference) discussed in Japanese Patent Application Laid-Open No. 08-317155 enables, for example, the following workflow. The user writes information to a paper document, for example, at a meeting (hereinafter such a document will be referred to as edited document), and then scans and files the document. Then, at a subsequent meeting, the user prints out the document and writes further information to the printed document.

Meanwhile, the user frequently writes information not only to marginal spaces but also to spaces between texts, figures, and other objects on the document. Accordingly, it is desirable that a printed document is provided with a sufficient amount of marginal spaces and spaces between objects to allow the user to write information. However, when the user repetitively performs the above-mentioned workflow including printing and writing, such spaces on the document will decrease and eventually run out.

In the descriptions of the present invention, marginal spaces and spaces between objects are collectively referred to as blank space.

### SUMMARY OF THE INVENTION

According to an aspect of the present invention, an image processing apparatus for generating print data used for printing objects to be printed contained in an electronic document to obtain a printed material includes: a setting unit configured to set a threshold value used for determining whether the printed material provides a sufficient amount of space not having the objects laid out therein; a determination unit configured to determine whether an occupancy rate of the objects on the printed material is larger than the set threshold value; a changing unit configured to perform, in a case where the occupancy rate is determined to be larger than the threshold value by the determination unit, processing for changing to the objects to reduce the occupancy rate thereof; and a print data generation unit configured to generate print data based on the objects that have been changed by the changing unit.

According to the present invention, when a filed document is printed out, the image processing apparatus determines whether the printed material provides a user-desired sufficient amount of blank space and, when the image processing apparatus determines an insufficient amount of blank space, generates a necessary amount of blank space before printing. Thus, it becomes easier to provide a printed material having the user-desired amount of blank space.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an internal structure of PDF data according to the present invention.

FIG. 2 is a block diagram illustrating an MFP according to the present invention.

FIG. 3 is a block diagram illustrating an exemplary configuration of a data processing unit 215 in FIG. 2.

FIG. 4 is a flow chart illustrating processing performed by a blank space generation unit 306 according to a first exemplary embodiment of the present invention.

FIGS. 5A, 5B, and 5C illustrate a concept of processing for generating a blank space.

FIGS. 6A, 6B, and 6C illustrate PDF data according to the present invention.

FIGS. 7A, 7B, and 7C illustrate the PDF data according to the present invention.

FIGS. 8A, 8B, and 8C illustrate a user interface screen displayed on an operation unit 203.

FIGS. 9A, 9B, and 9C illustrate the user interface screen displayed on the operation unit 203.

FIG. 10 illustrates a blank space determination reference setting screen displayed on the operation unit 203.

FIG. 11 is a flow chart illustrating processing for scanning a document.

FIG. 12 is a flow chart illustrating processing performed by the blank space generation unit 306 according to a second exemplary embodiment.

FIG. 13 illustrates an exemplary screen for setting an object data selection mode at the time of blank space generation displayed on the operation unit 203 according to the second exemplary embodiment.

FIG. 14 illustrates an exemplary screen for setting an object data selection rule at the time of blank space generation displayed on the operation unit 203 according to the second exemplary embodiment.

FIGS. 15A and 15B illustrate an exemplary user interface screen displayed on the operation unit 203 according to the second exemplary embodiment.

### DESCRIPTION OF THE EMBODIMENTS

Various exemplary embodiments, features, and aspects of the invention will be described in detail below with reference to the drawings.

### <Configuration of Image Processing Apparatus>

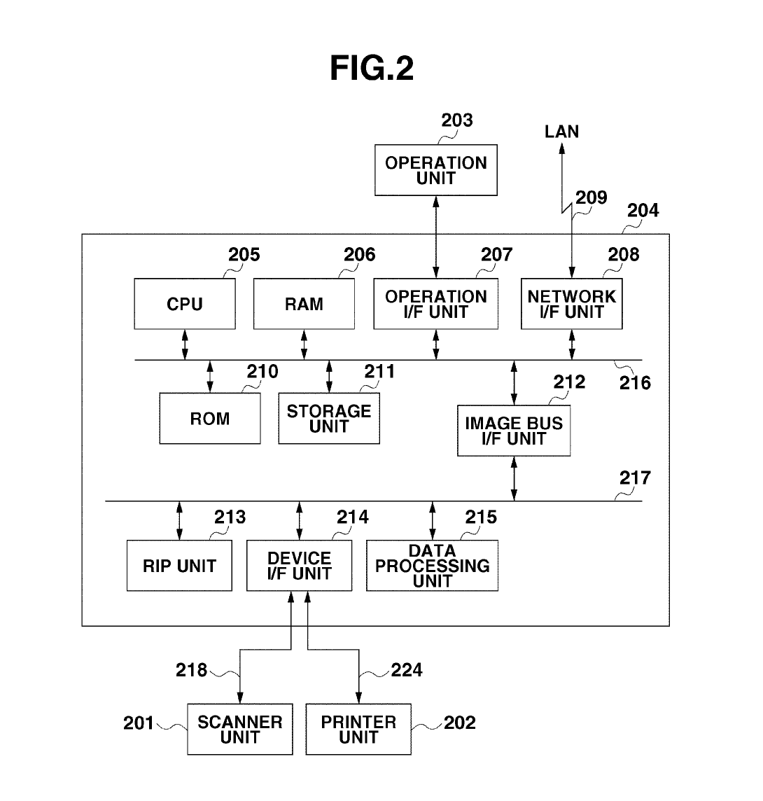

FIG. 2 illustrates a detailed configuration of a multifunction peripheral (MFP) used as an image processing apparatus according to a first exemplary embodiment.

The MFP includes a scanner unit 201 (i.e., image input device), a printer unit 202 (i.e., image output device), an operation unit 203 (i.e., user interface) such as a touch panel, and a control unit 204 including a central processing unit (CPU) 205, and memory. The control unit 204 serves as a controller which inputs and outputs image information and device information. The control unit 204 is connected with the scanner unit 201, the printer unit 202, and the operation unit 203. Further, the control unit 204 communicates with external apparatuses via a local area network (LAN) 209.

The CPU 205 is an information processing unit (computer) which controls the entire system. A random access memory (RAM) 206 serves not only as a system work memory for the operation of the CPU 205 but also as an image memory for temporarily storing image data. A read-only memory (ROM) 210 is a boot ROM which stores a boot program and other system programs.

A storage unit 211 is a hard disk drive which stores system control software, image data, electronic documents, and so on. An operation unit interface (I/F) 207, which is an interface with the operation unit (user interface (UI)) 203, outputs to the operation unit 203 image data to be displayed thereon.

The operation unit I/F 207 transmits to the CPU 205 information about an instruction input by a user of the image processing apparatus via the operation unit 203. A network interface (I/F) unit 208 connects the image processing apparatus to the LAN 209 to input and output packet format information. The above-mentioned devices are arranged on a system bus 216.

An image bus I/F unit 212 serves as a bus bridge which connects the system bus 216 and an image bus 217, which transmits image data at high speed, for data structure conversion between the two buses. The image bus 217 is composed of, for example, a PCI bus or IEEE 1394.

A raster image processor (RIP) 213, a device I/F unit 214, a data processing unit 215) are arranged on the image bus 217. The RIP 213 analyzes the page description language (PDL) code and rasterizes it to bitmap image with a specified resolution, i.e., performs what is called rendering processing. In rasterization to bitmap image, attribute information is added thereto on a pixel or area basis.

This processing is referred to as image area determination processing. The image area determination processing adds attribute information representing the object type (text, line, graphic, image, etc.) on a pixel or area basis. For example, an image area signal is output from the RIP 213 according to the type of PDL-based object contained in the PDL code, and attribute information for the attribute represented by the signal value is stored in association with the pixel and area for the object.

Therefore, the image data is provided with associated attribute information. The device I/F unit 214 connects the scanner unit 201 (image input device) to the control unit 204 via a signal line 218, and connects the printer unit 202 (image output device) thereto via a signal line 219, and performs image data conversion between synchronous and asynchronous systems.

### <Data Processing Unit>

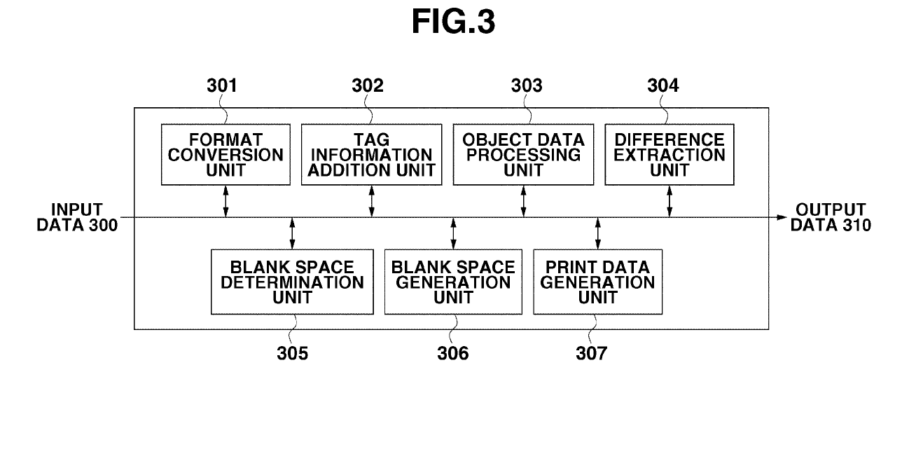

The data processing unit 215 in FIG. 2 will be described in detail below with reference to FIG. 3. The data processing unit 215 includes a format conversion unit 301, a tag information addition unit 302, an object data processing unit 303, a difference extraction unit 304, a blank space determination unit 305, a blank space generation unit 306, and a print data generation unit 307.

In the present exemplary embodiment, each processing unit (each processing unit in FIG. 3) of the data processing unit 215 is implemented when the computer executes relevant computer programs stored in a computer-readable storage medium, but the method for implementing each processing unit is not limited thereto. For example, the data processing unit 215 (each processing unit in FIG. 3) may be partially or entirely implemented by hardware such as electronic circuits.

When the data processing unit 215 receives input data 300, it performs processing by using the processing units 301 to 307, and outputs output data 310. The input data 300 refers to bitmap data (image data) obtained by scanning a document by the scanner unit 201, or bitmap data and electronic document data stored in the storage unit 211.

Electronic document data refers to electronic documents with formats like PDF, XPS, and OfficeOpenXML. The output data 310 (bitmap data or electronic document data) is stored in the storage unit 211, printed out by the printer unit 202, and transmitted to external apparatuses (not illustrated) connected via the LAN 209. In the present exemplary embodiment, electronic document data will be described as PDF (hereinafter referred to as PDF data).

### <PDF Data>

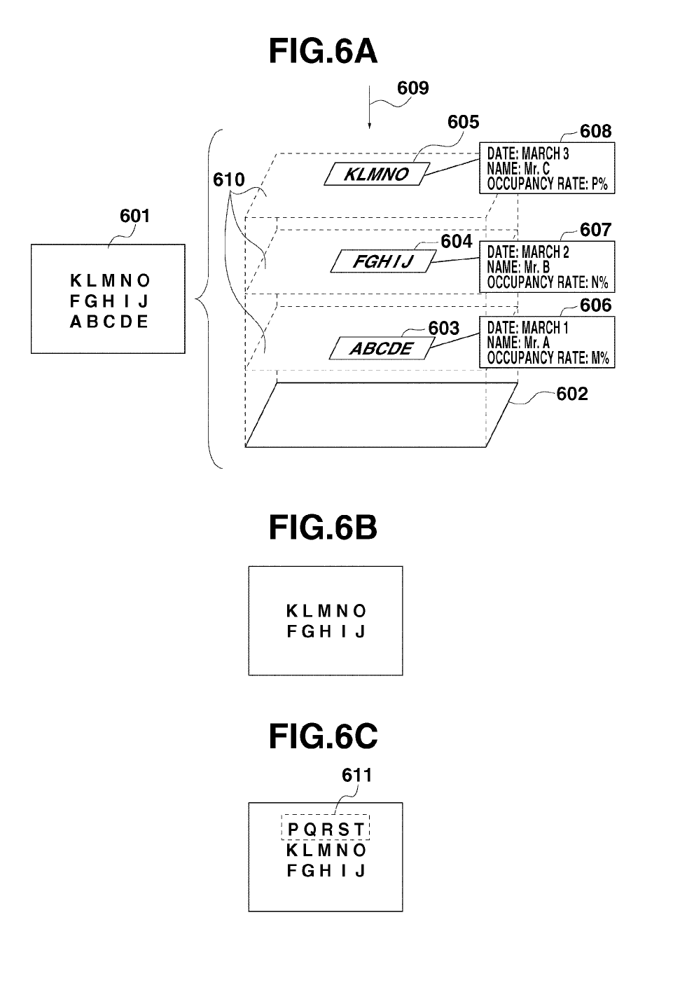

PDF data will be described below with reference to FIG. 6A. FIG. 6A illustrates a concept of PDF data stored in the storage unit 211. Adobe Reader (trademark) is an example of software that can render PDF data. In the present exemplary embodiment, PDF data can be displayed also on the operation unit 203 (described below).

JPEG data 601 in FIG. 6A is exemplary PDF data stored in the storage unit 211. Each of JPEG data 602 to 605 schematically illustrates a hierarchical structure (layer structure) of the PDF data 601. The JPEG data 602 represents a background image, and JPEG data 603 to 605 represent character string data (object data of character strings) rendered on the background.

In the present exemplary embodiment, the JPEG data 602 includes, for example, only white pixels, and the JPEG data 603, 604, and 605 include bitmap image character strings “ABCDE”, “FGHIJ”, and “KLMNO”, respectively.

PDF data is not limited to JPEG data as long as PDF data can be internally stored, but may be, for example, MMR data, ZIP data, etc. Further, the information constituting JPEG data is not limited to character strings but may be other object data such as photographs, graphics, illustrations, etc.

When PDF data is represented by the hierarchical structure, each hierarchical level is referred to as a layer. Specifically, each of the JPEG data 602 to 605 is a layer constituting the PDF data 601. With layer representation of the PDF data, when the JPEG data 602 to 605 are rendered in this order on an overlapped basis, the PDF data can be seen as the PDF data 601 when the image is viewed from the direction of an arrow 609.

Since a portion 610 other than an object (each of the JPEG data 603 to 605) is transparent in each layer, the JPEG data 602 (background) can be seen through a circumferential portion of the JPEG data 603 to 605 when the image is viewed from the direction of the arrow 609.

When the JPEG data 605 is positionally overlapped onto the JPEG data 603 and 604, overlapped portions of the JPEG data 603 and 604 in the layers under the JPEG data 605 are not visible when the image is viewed from the direction of the arrow 609.

In the example in FIG. 6A, the JPEG data 603 to 605 are not positionally overlapped, and accordingly the image can be seen as the PDF data 601 when viewed from the direction of the arrow 609.

In the present exemplary embodiment, all the layers of the JPEG data 603 to 605 will be referred to as object data for the convenience of explanation.

Referring to FIG. 6A, tag information 606 to 608 is added to the object data 603 to 605, respectively. For example, tag information “(Date: March 1), (Name: Mr. A), (Occupancy rate: M %)” is added to the object data 603. The tag information 606 to 608 is used based on CONDITIONS on the operation unit 203 (described below). The occupancy rate will be described below.

### <Structure of PDF Data>

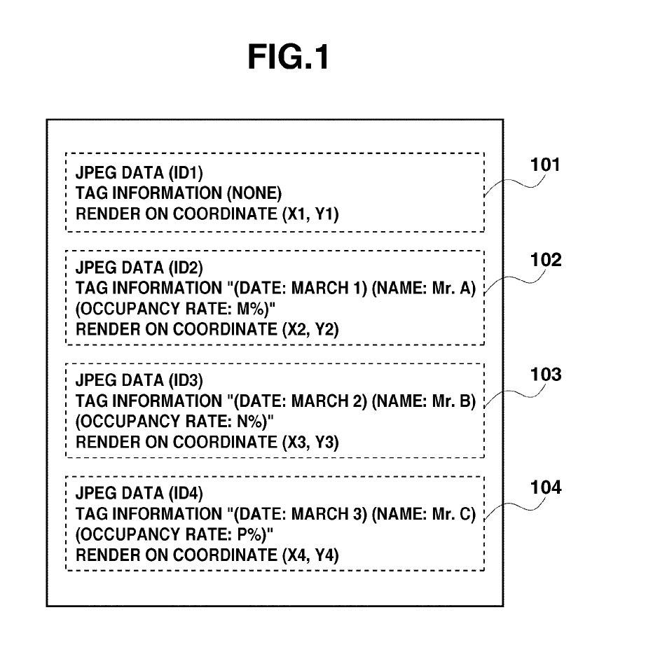

The internal structure of PDF data will be described below with reference to FIG. 1. The schematic diagram of the PDF data illustrated in FIG. 6A has the internal data structure illustrated in FIG. 1. The object data 602 to 605 in FIG. 6A corresponds to the JPEG data 101 to 104 in FIG. 1, respectively.

For example, the object data 603 in FIG. 6A corresponds to the object data 102 in FIG. 1. The object data 602 representing the background in FIG. 6A corresponds to the object data 101 in FIG. 1. Each of the object data 101 to 104 is assumed to be described using the PostScript (PS) language for configuring PDF data.

The object data 102 (corresponding to the object 603 in FIG. 6A) in FIG. 1 is JPEG data having an object ID of 2 as object ID information.

Tag information “(Date: March 1), (Name: Mr. A), (Occupancy rate: M %).” is associated with the object data 102. Specifically, when object data is retrieved using tag information “March 1”, for example, the object data 102 will be extracted. “Render on coordinate (X2, Y2)” is an instruction for rendering JPEG data (ID2) on a coordinate (X2, Y2).

### <Operation Unit>

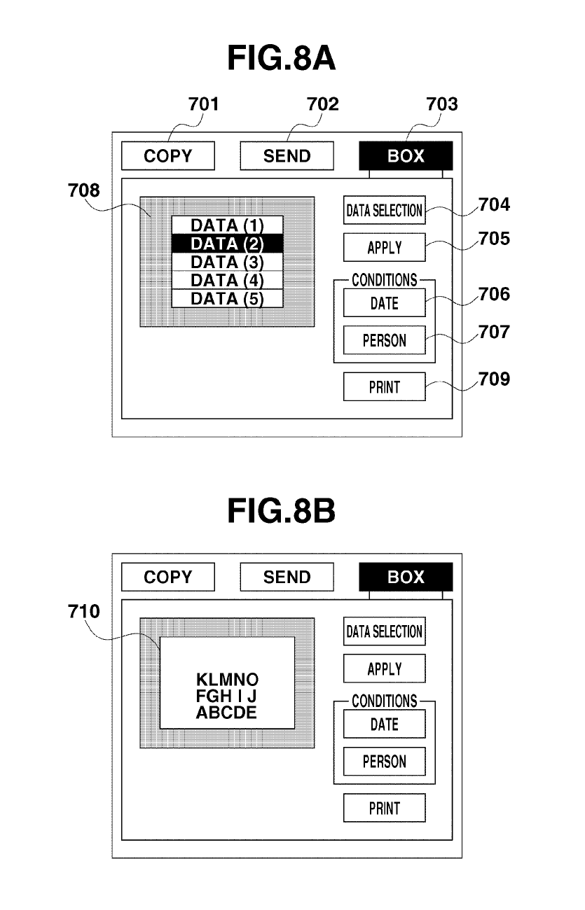

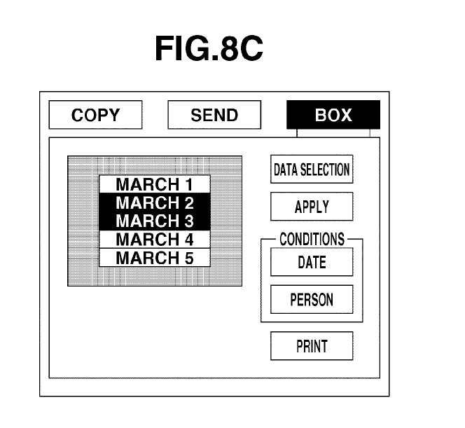

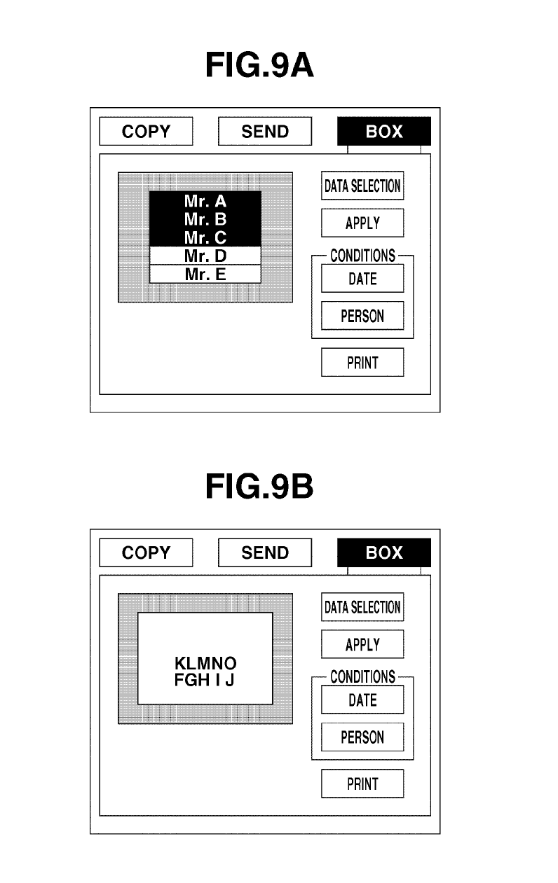

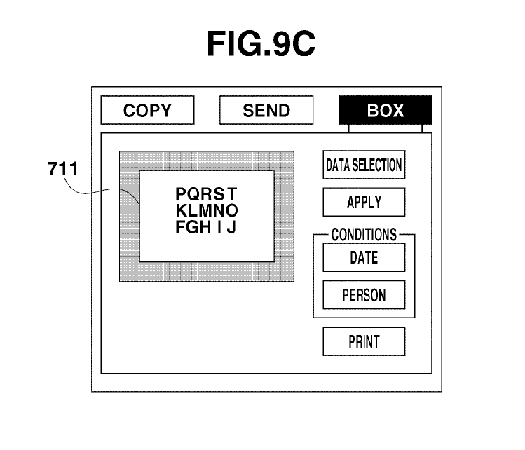

The operation unit 203 will be described in detail below with reference to the user interface screens illustrated in FIGS. 8A, 8B, and 8C and FIGS. 9A, 9B and 9C. Although the present exemplary embodiment will be described below based on the operation unit 203 connected to the MFP, the operation unit is not limited thereto but may be a similar operation unit of a host computer connected via the LAN 209.

FIG. 8A illustrates an exemplary screen displayed on the operation unit 203 on the MFP. A COPY button 701 is used to activate the copy function. When the user selects the COPY button 701, the copy function is activated and a relevant setting screen appears. In the setting screen, the user makes settings for printing out a document image (scanned by the scanner unit 201) by the printer unit 202.

A SEND button 702 is used to activate the send function. When the user selects the SEND button 702, the send function is activated and a relevant setting screen appears. In the setting screen, the user makes settings for storing a document image read by the scanner unit 201 in the storage unit 211 and transmitting it to an external apparatus via a network as bitmap data or electronic document data.

A BOX button 703 is used to activate the box function. When the user selects the BOX button 703, the box function is activated and a relevant setting screen appears. In the setting screen, the user makes settings for loading bitmap data and electronic document data stored in the storage unit 211, printing them out on the printer unit 202, and sending them to an external apparatus via the network.

The screen in FIG. 8A appears when the BOX button 703 for the box function is selected. The box function according to the present exemplary embodiment allows the user to select electronic document data stored in the storage unit 211 and then issue an instruction about condition setting. Data selection and condition setting will be described in detail below.

When the user selects the BOX button 703, a DATA SELECTION button 704, an APPLY button 705, a DATE button 706, a PERSON button 707, a display window 708, and a PRINT button 709 are displayed as illustrated in the screen in FIG. 8A. When the user presses the DATA SELECTION button 704, a list of electronic document data stored in the storage unit 211 appears in the display window 708. When the user presses desired data to select it from the list, the selected data is highlighted.

The display window 708 of the screen in FIG. 8A displays, for example, five data items (data (1) to (5)) of which the data (2) is selected (highlighted).

When the user presses the APPLY button 705, an image of the data currently selected in the list (or thumbnail image) appears in the display window 708. The display window 708 of the screen in FIG. 8B displays an image 710 of the data (2) selected as an example.

The data (2) is assumed to have a data structure as illustrated in FIG. 1. When the user presses the PRINT button 709, the image 710 of the data (2) stored in the storage unit 211 is printed out.

At the time of printing, address information representing the location of the data (2) and object ID information representing an ID of the printed object data may be embedded in the image of the data (2) as a code image pattern (for example, QR code), and then printed out. When a printed material having such a code image pattern is scanned, it becomes easier to identify an original document and extract a difference.

In the present exemplary embodiment, when the image 710 of the selected data (2) is displayed, conditions can be set based on tag information by a user's instruction before issuing a printing instruction. In the present exemplary embodiment, a condition about date and a condition about person can be set as conditions.

For example, when the user presses the DATE button 706, a date list or a calendar for selecting a condition about date appears in the display window 708. Then, when the user presses a desired date, the pressed date is selected and highlighted.

As an example, five different dates (March 1 to March 5) are displayed in the display window 708 of the screen in FIG. 8C, where March 2 and March 3 are selected. Similarly, when the user presses the PERSON button 707, a list of person names for selecting a condition about person appears in the display window 708.

Then, when the user presses a desired person name, the pressed name is highlighted and selected. As an example, five names (Mr. A to Mr. E) are displayed in the display window 708 of the screen in FIG. 9A, where Mr. A, Mr. B, and Mr. C are selected.

When the user completes the above-mentioned condition setting and then presses the APPLY button 705, the set conditions are applied to the image 710 of the data (2). Specifically, the background image data and the object data of the portions associated with the tag information satisfying the following conditional expression are displayed in the image 710.

Conditional formula=((March 2) OR (March 3)) AND ((Mr. A) OR (Mr. B) OR (Mr. C))
The conditional expression is stored in a storage unit such as the RAM 206 as a condition parameter.

For example, when only March 1 is selected as a condition about date and only Mr. B is selected as a condition about person, a conditional expression becomes as follows.

Conditional expression=(March 1) AND (Mr. B)

Conditions that can be set are not limited to a condition about date and a condition about person but may be other conditions, for example, an attribute condition such as text, photograph, graphic, illustration, etc.

Portions satisfying the above-mentioned conditional expression (((March 2) OR (March 3)) AND ((Mr. A) OR (Mr. B) OR (Mr. C))) are displayed in the display window 708 of the screen in FIG. 9B. Since the displayed image is generated by the object extracted from the data (2), it is referred to as data (2′).

When the user presses the PRINT button 709, the data (2′) extracted from the data (2) stored in the storage unit 211 is printed out. In this case, it is desirable that the address information representing the location of the data (2) in the storage unit 211, and the object ID information representing an ID of the object data printed out as data (2′) are embedded in the image of the data (2′) as a QR code (code image pattern) and then printed out.

### <Object Data Processing Unit>

The object data processing unit 303 has a function to extract object data from electronic document data stored in the storage unit 211 based on condition parameters and tag information stored in a storage unit such as the RAM 206. The above descriptions will be supplemented with reference to the PDF data in FIG. 6A.

The data (2) selected in the display window 708 in FIG. 8A is assumed to be the PDF data 601 in FIG. 6A. Since condition setting is not made for the image 710 displayed in the display window 708 in FIG. 8B, the PDF data 601 is displayed as it is. The data (2′) is an image generated by object data extracted from the data (2) according to a set condition as mentioned above.

In the case of conditional expression=((March 2) OR (March 3)) AND ((Mr. A) OR (Mr. B) OR (Mr. C)), the object data 604 and 605 are extracted from the object data 603 to 605 contained in the PDF data 601 based on the tag information 606 to 608. The object data 603 is not extracted because the condition about date is not satisfied although the condition about person is satisfied.

The object data processing unit 303 also has a function to combine the extracted object data to generate bitmap data. FIG. 6B schematically illustrates a state where the object data 604 and 605 are combined. The object data after combination is assumed to be bitmap data.

The object data processing unit 303 also has a function to generate object data from a difference extracted by the difference extraction unit 304 (described below).

The object data processing unit 303 also has a function to extract, when the QR code is contained in a scanned image, object data from relevant electronic document data based on the address information (electronic document identification information) and the object ID information acquired from the QR code.

### <Difference Extraction>

The difference extraction unit 304 extracts a difference between the bitmap data read by the scanner unit 201 and the data combined by the object data processing unit 303 (original data printed out). Specifically, the difference extraction unit 304 extracts as differential portions newly added to the printed document by the user.

The above descriptions will be supplemented with reference to FIGS. 6B and 6C. FIG. 6B illustrates bitmap data generated by combining the object data 604 and 605. FIG. 6C illustrates a state where the user has written (added) information to the paper document of the bitmap data in FIG. 6B.

The user has written a character string 611 illustrated in FIG. 6C. The difference extraction unit 304 extracts a difference between the bitmap data in FIG. 6B and the bitmap data in FIG. 6C read by the scanner unit 201. In the present exemplary embodiment, binary processing is applied to each image and the images are compared on a pixel basis as an exemplary difference extraction method.

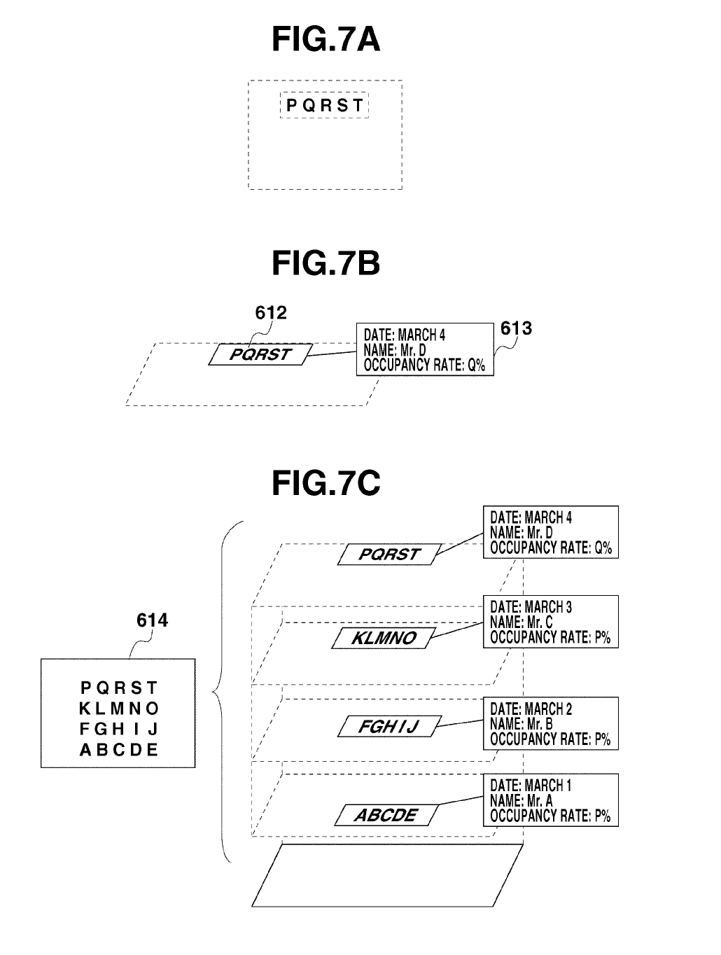

The resultant differential bitmap data is illustrated in FIG. 7A. The object data processing unit 303 generates object data 612 from the differential bitmap data illustrated in FIG. 7A. In the present exemplary embodiment, object data is converted into JPEG-compressed data.

When the QR code is added, since the bitmap data of the object contained in the electronic document data stored in the storage unit can be easily identified, comparison at the time of extraction of a difference can be easily performed.

When the QR code is not added, the electronic document data used for printing can also be identified by extracting objects contained in the bitmap data of the scanned document and comparing the extracted objects with objects stored in the storage unit.

### <Tag Information Addition Unit>

The tag information addition unit 302 adds tag information to the object data newly generated by the object data processing unit 303. Exemplary tag information includes date information and personal information. Date information and personal information include newly created date information and personal information, and edited date information and personal information.

In the present exemplary embodiment, the occupancy rate of object data is also added as tag information. In the present exemplary embodiment, after the difference extraction unit 304 extracts a difference, the operation unit 203 displays a tag information input screen to allow the user to enter tag information such as personal information which is added to the object data.

As other methods, information to be added to the object data as tag information may be specified in advance via the operation unit 203 before reading a paper document via the scanner unit 201. Further, a scanned date may be added to the object data as default tag information.

The occupancy rate, which is a ratio of the area occupied by the object data to the area of the paper document (described below), will be calculated and then added thereto. The object data 612 generated by the object data processing unit 303 and tag information 613 added by the tag information addition unit 302 are illustrated in the schematic diagram in FIG. 7B. The tag information 613 “(Date: March 4), (Name: Mr. D), (Occupancy rate: Q %)” is added to the object data 612 so as to be associated therewith.

### <Format Conversion Unit>

The format conversion unit 301 additionally stores the object data newly generated by the object data processing unit 303 and the tag information added by the tag information addition unit 302 for the electronic document data stored in the storage unit 211.

In the present exemplary embodiment, new object data and tag information are converted into PDF data stored in a new layer. The PDF data formed as a result of conversion is illustrated in FIG. 7C. FIG. 9C illustrates the display window 708 of the operation unit 203 displaying the PDF data in FIG. 7C when setting is made to display objects having tag information of a date from March 2 to March 4.

Since added portions (difference) are extracted and then additionally stored in the original electronic document data in this way, the amount of data capacity required for storage can be reduced and efficient data update becomes possible.

### <Blank Space Determination Unit>

The blank space determination unit 305 obtains the occupancy rate of the area of each piece of object data generated by the object data processing unit 303. The above descriptions will be supplemented with reference to the example in FIG. 6A.

The blank space determination unit 305 calculates the ratio of the area of the object data 603, 604, and 605 to the area of the JPEG data 602 (blank paper), i.e., the area of the document to be output.

The blank space determination unit 305 transmits a result of the calculation to the tag information addition unit 302 as the occupancy rate (occupancy area information). As a result, the tag information addition unit 302 adds the received information about the occupancy rate to each object as tag information.

When an instruction for printing an electronic document is issued, the blank space determination unit 305 also determines whether there is a user-desired amount of blank space (marginal spaces and spaces between objects).

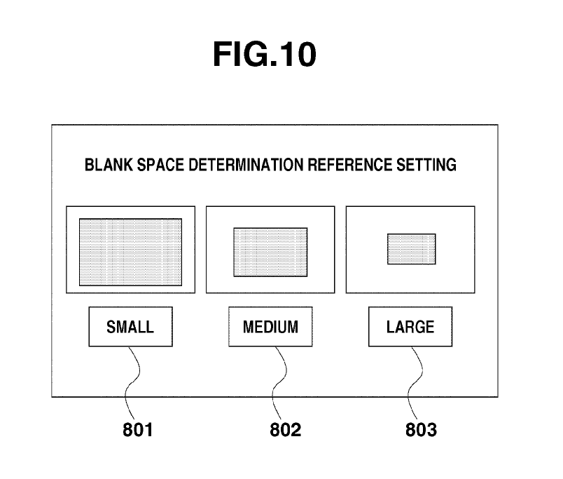

The blank space determination unit 305 prestores a user-desired occupancy rate threshold value. For example, as illustrated in FIG. 10, a blank space determination reference setting screen for setting an occupancy rate threshold value used as a reference for blank space determination appears on the operation unit 203, allowing the user to enter a desired occupancy rate. Buttons 801, 802, and 803 are used to select an area of blank space for writing information.

When the user presses any one of the buttons 801, 802, and 803, the blank space determination unit 305 stores an occupancy rate threshold value corresponding to the selection. For example, when the user presses the button 801, an object occupancy rate of 80% (i.e., a blank space occupancy rate of 20%) is stored. When the user presses the button 802, an object occupancy rate of 50% (i.e., a blank space occupancy rate of 50%) is set. When the user presses the button 803, an object occupancy rate of 20% (i.e., a blank space occupancy rate of 80%) is set.

The above explanations will be supplemented with reference to an example in which PDF data as illustrated in FIG. 6A is printed. First of all, the blank space determination unit 305 totals the occupancy rates described in the tag information 606, 607, and 608 for the object data 603, 604, and 605, respectively, to be printed in the PDF data 601. The blank space determination unit 305 compares the total occupancy rate with a preset occupancy rate threshold value.

When the blank space determination unit 305 determines that the total occupancy rate is larger than the threshold value based on a result of the comparison, it transmits to the blank space generation unit 306 insufficient blank space information notifying that the blank space is smaller than the desired threshold value. When the blank space determination unit 305 determines that the total occupancy rate is equal to or smaller than the threshold value, it does not transmit the insufficient blank space information to the blank space generation unit 306.

### <Blank Space Generation Unit>

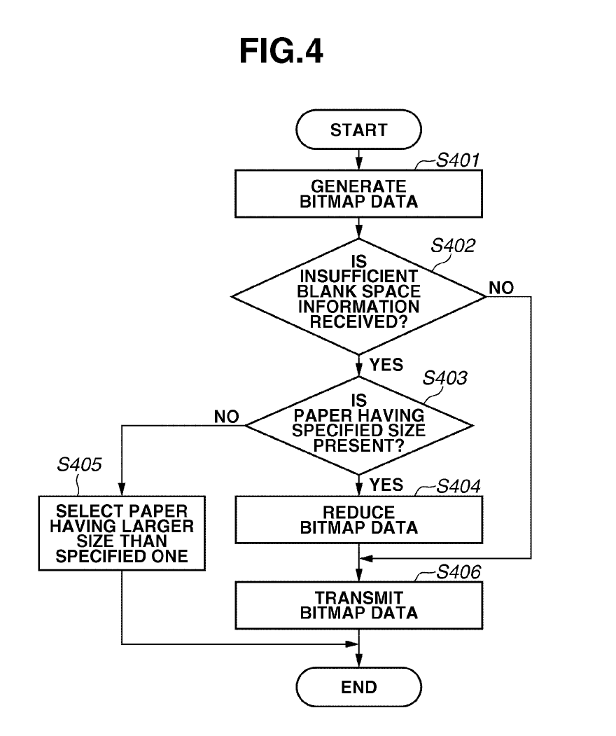

To generate the user-desired amount of blank space, the blank space generation unit 306 determines a layout for printing by the printer unit 202. The processing performed by the blank space generation unit 306 will be described in detail below with reference to the flow chart in FIG. 4.

In step S401, the blank space generation unit 306 renders object data to be printed in the PDF data 601 to generate bitmap data. In step S402, the blank space generation unit 306 determines whether insufficient blank space information has been received from the blank space determination unit 305.

When the insufficient blank space information has not been received (NO in step S402), the blank space determination unit 305 determines that there exists an amount of blank space equal to or larger than the user-desired amount, and the processing proceeds to step S406. In step S406, the blank space generation unit 306 transmits to the print data generation unit 307 the bitmap data rendered in step S401.

On the other hand, when the insufficient blank space information has been received (YES in step S402), the processing proceeds to step S403. In step S403, the blank space generation unit 306 determines whether paper having the size specified in the PDF data 601 is present in the image processing apparatus (MFP).

When the blank space generation unit 306 determines that paper having the specified size is present (YES in step S403), the processing proceeds to step S404. In step S404, the blank space generation unit 306 reduces the bitmap data so that the object occupancy rate becomes equal to or smaller than the desired threshold value (in other words, a sufficient blank space is generated). In step S406, the blank space generation unit 306 transmits the reduced bitmap data to the print data generation unit 307.

On the other hand, when the blank space generation unit 306 determines that paper having the specified size is not present (NO in step S403), the processing proceeds to step S405. In step S405, the blank space generation unit 306 selects paper having a size larger than the paper size specified in the PDF data 601. In this case, the blank space generation unit 306 selects such paper that the object occupancy rate does not exceed the desired threshold value.

When the object occupancy rate does not become equal to or smaller than the desired threshold value when the blank space generation unit 306 selects paper having the largest size prepared by the image processing apparatus, the blank space generation unit 306 also performs processing for reducing bitmap image data. In step S406, the blank space generation unit 306 transmits to the print data generation unit 307 the bitmap data (or bitmap data reduced as required) together with the paper size.

In steps S404 and S405, a position where bitmap data is laid out is also determined. In step S406, therefore, the arrangement information is also transmitted together.

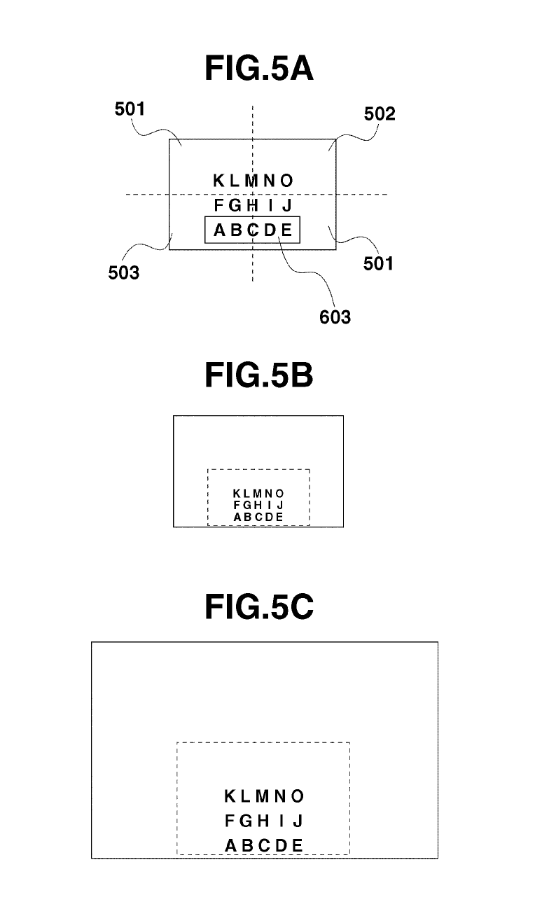

An exemplary processing method performed in steps S404 or S405 will be described below with reference to FIGS. 5A to 5C. In the present exemplary embodiment, when reducing bitmap data in step S404, a layout for reduced bitmap data is determined based on the position of the oldest object (in other words, the position of the object that has been stored in the document since it was printed for the first time).

Therefore, the blank space generation unit 306 determines first the object data 603, which is the oldest object in the PDF data 601, based on the date information, and determines the position of the object data 603 on the paper. In determining the position of the object data 603, the blank space generation unit 306 determines which of division areas 501 to 504 (formed by dividing the PDF data 601 into four) the position of the object data 603 belongs to, as illustrated in FIG. 5A. The blank space generation unit 306 determines whether the reduced image is to be justified in the horizontal or vertical direction.

When the oldest object data has been positioned only in one area, the reduced image will be justified toward that area. For example, when the oldest object data is positioned only in the top left division area 501, the reduced image is justified toward the top left division area 501.

Further, when the oldest object is positioned over two different division areas, it will be justified toward these areas. In the example in FIG. 5A, since the oldest object data 603 is positioned over the bottom left division area 503 and the bottom right division area 504, the reduced image is laterally centered and justified to the bottom of the PDF data 601, as illustrated in FIG. 5B.

Further, when the oldest object data is positioned over three or more different areas, the reduced image will be laid out at the center of the document. Although, in the present exemplary embodiment, the reduced image is laid out in this way since the user frequently adds information with reference to the oldest object, the layout of the reduced image is not limited thereto in the present invention.

Further, in the present exemplary embodiment, in the case of printing on paper having a size larger than the paper size specified in the PDF data in step S405, the layout is determined based on the position of the oldest object (in other words, the position of the object that has been stored in the document since it was printed for the first time).

In determining the layout, a determination method similar to the above-mentioned one in step S404 can be used. Specifically, when the PDF data 601 is divided into four division areas, the blank space generation unit 306 determines whether the reduced image is to be justified in the horizontal or vertical direction based on a result of the determination which of the division areas 501 to 504 the position of the object data 603 belongs to. For example, in the example in FIG. 5A, since the oldest object data 603 is positioned over the bottom left division area 503 and the bottom right division area 504, the reduced image is laterally centered and justified to the bottom of the PDF data 601, as illustrated in FIG. 5C.

### <Print Data Generation Unit>

The print data generation unit 307 applies image processing for printing to the bitmap data laid out so as to provide a sufficient amount of blank space generated by the blank space generation unit 306, to generate print data, and transmits the generated print data to the printer unit 202. The image processing for printing refers to color processing and image formation processing. Upon reception of the print data, the printer unit 202 prints out the data.

The present invention will be summarized below with reference to the example in FIG. 6A. PDF data stored in the storage unit 211 is as illustrated in FIG. 6A. When a printing instruction is issued after the user set conditions for the object to be printed to the PDF data, the blank space determination unit 305 compares the object occupancy rate with the preset occupancy rate threshold value to determine whether there is a sufficient amount of blank space, i.e., a writing space, for the user to add further information.

When the blank space determination unit 305 determines that there is not a sufficient amount of blank space, it performs processing for generating a blank space (processing for allocating a writing space) and then prints out the document. The thus-configured print data enables the user to efficiently generate a printed material having the user-desired amount of blank space.

<Detailed Processing when Scanning>

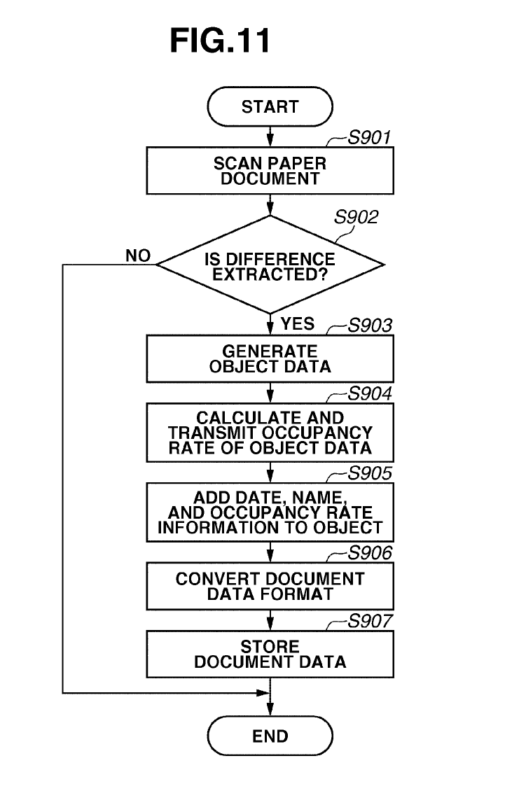

FIG. 11 is a flow chart illustrating in detail processing performed to scan a document by the difference extraction unit 304, the object data processing unit 303, the blank space determination unit 305, the tag information addition unit 302, and the format conversion unit 301.

The difference extraction unit 304 extracts a difference between the document image to which information has been added and the electronic document data stored in the storage unit 211, generates object data from the extracted difference, calculates the occupancy rate of the object data, updates the electronic document data, and stores it in the storage unit 211. Programs for operating the CPU 205, serving as processing units for performing the processing of the flow chart in FIG. 11, are stored in the ROM 210 or the storage unit 211 (computer-readable storage medium).

In step S901, the control unit 204 scans a paper document using the scanner unit 201, and inputs bitmap data after predetermined scanned image processing to the data processing unit 215. Scanned image processing includes, for example, base color removal processing, color conversion processing, and filter processing.

In step S902, the difference extraction unit 304 of the data processing unit 215 generates bitmap data of the electronic document data to be subjected to comparison loaded from the storage unit 211, and then determines whether there is a difference between the bitmap data acquired in step S901 and the bitmap data generated from the electronic document data.

When there is no difference (NO in step S902), the processing ends. When there is a difference (YES in step S902), the processing proceeds to step S903. In step S903, the object data processing unit 303 generates object data from the extracted difference.

The loaded electronic document data to be subjected to comparison may be identified from an identifier such as the QR code added to the paper document. Further, it may be possible to extract objects contained in the bitmap data of the scanned paper document, and compare the extracted objects with objects stored in the storage unit to identify the electronic document data of the paper document used for printing.

In step S904, the blank space determination unit 305 calculates the occupancy rate of the generated object data, and transmits the calculated occupancy rate to the tag information addition unit 302 as occupancy rate information.

In step S905, the tag information addition unit 302 adds tag information such as date, name, and occupancy rate to the object data generated in step S903.

In step S906, the format conversion unit 301 additionally stores the object data newly generated in step S903 and the tag information added thereto in step S905 to the electronic document data loaded in step S902, thus converting the loaded electronic document data into an electronic document data (PDF data) having the new object data and tag information stored in a new layer.

In step S907, the control unit 204 stores in the storage unit 211 the electronic document data converted in step S906, and then the processing ends.

In this way, the blank space determination unit 305 determines whether there is a sufficient amount of blank space (marginal spaces and spaces between objects) in the data to be printed before printing out an electronic document managed by electronic document filing.

When there is not a sufficient amount of blank space, the blank space generation unit 306 applies reduction processing and change processing such as paper size change to the object data to change the object data so that a sufficient amount of blank space is provided. Thus, the user-desired amount of blank space can be constantly provided in the printed material.

Further, when the user set conditions, it becomes possible to select any desired objects before printing out and determine whether there is a sufficient amount of blank space for the selected objects. Even when the user adds information to the printed material having the user-desired information printed thereon, a difference can be easily extracted by comparing objects in the printed material with object counterparts in the original electronic document, thus enabling the differential object data to be additionally stored in the original electronic document.

In the first exemplary embodiment, a sufficient amount of blank space can be provided by reducing the layout in step S404 and changing the paper size in step S405. However, some users may not want to reduce the layout or change the paper size.

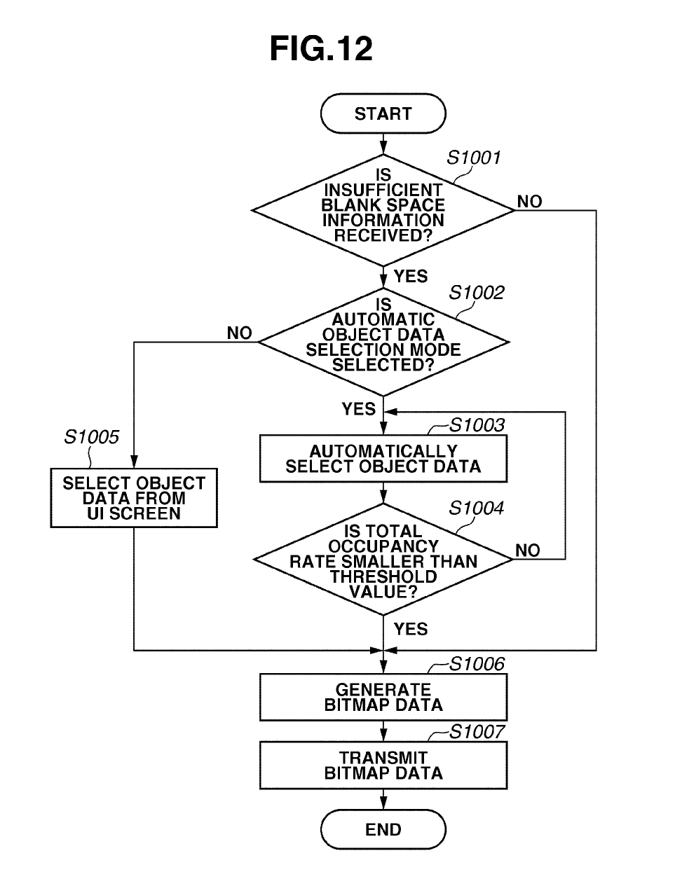

A second exemplary embodiment applies another method for generating the user-desired amount of blank space. This method will be described below with reference to the flow chart in FIG. 12.

In step S1001, the blank space generation unit 306 determines whether insufficient blank space information has been received from the blank space determination unit 305. When insufficient blank space information has not received (NO in step S1001), the blank space determination unit 305 determines that there exists an amount of blank space equal to or larger than the user-desired amount, and the processing proceeds to step S1006. In step S1006, the blank space generation unit 306 renders the PDF data 601 to generate bitmap data.

In step S1007, the blank space generation unit 306 transmits to the print data generation unit 307 the bitmap data rendered in step S1006.

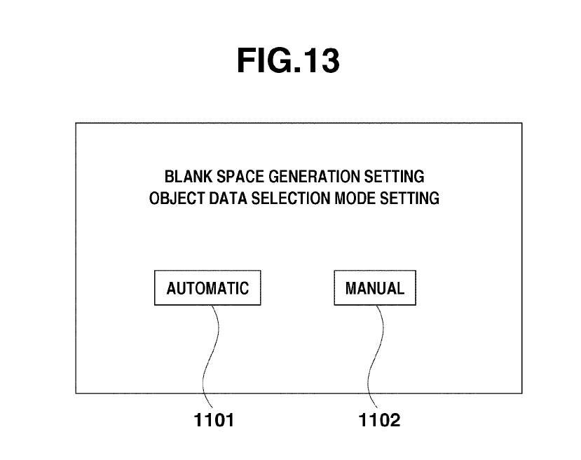

On the other hand, when the insufficient blank space information has been received (YES in step S1001), the processing proceeds to step S1002. In step S1002, the blank space generation unit 306 determines which of the automatic and manual object data selection modes is set by the user. The object data selection mode is set by the user via a screen as illustrated in FIG. 13.

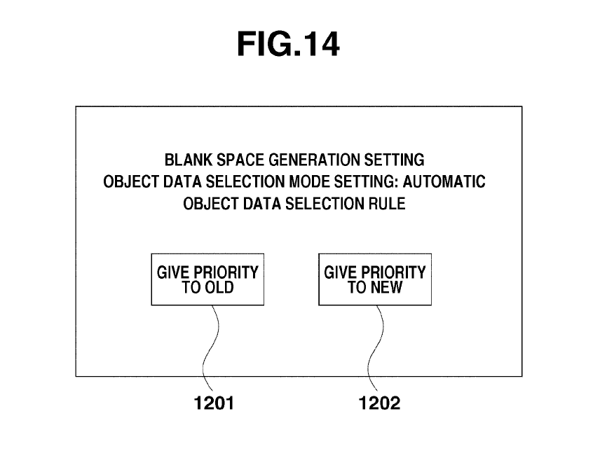

The user may preset the object data selection mode or set the object data selection mode in step S1002. When the user selects the “AUTOMATIC” button 1101 in FIG. 13, i.e., when the blank space generation unit 306 determines that the automatic object data selection mode is currently selected (YES in step S1002), a screen as illustrated in FIG. 14 appears allowing the user to set an object data selection rule.

In step S1003, the blank space generation unit 306 selects object data to be printed according to the object data selection rule set by the user.

FIG. 14 illustrates an exemplary user interface for specifying whether printing is made giving priority to old objects (a button 1201) or to new objects (a button 1202) based on the date tag information. For example, when the user selects the button 1202, printing is made giving priority to objects having a new date. In step S1003, therefore, objects having an old date will be excluded from objects to be printed in order of the date (the object having the oldest date is excluded first).

When the user selects a button 1201, printing is made giving priority to objects having an old date. Therefore, objects having a new date will be excluded from objects to be printed in order of the date (the object having the latest date is excluded first).

In step S1004, the blank space determination unit 305 calculates the total occupancy rate of the object data selected in step S1003, and determines whether the total occupancy rate is smaller than the prestored user-desired occupancy rate threshold value.

When the blank space determination unit 305 determines that the total occupancy rate is equal to or larger than the prestored user-desired occupancy rate threshold value (NO in step S1004), the processing returns to step S1003 to increase the amount of objects to be excluded from objects to be printed and then reselects objects to be printed. When the blank space determination unit 305 determines that the total occupancy rate is smaller than the prestored occupancy rate threshold value (YES in step S1004), the processing proceeds to step S1006. In step S1006, the blank space generation unit 306 renders the selected object data to generate bitmap data.

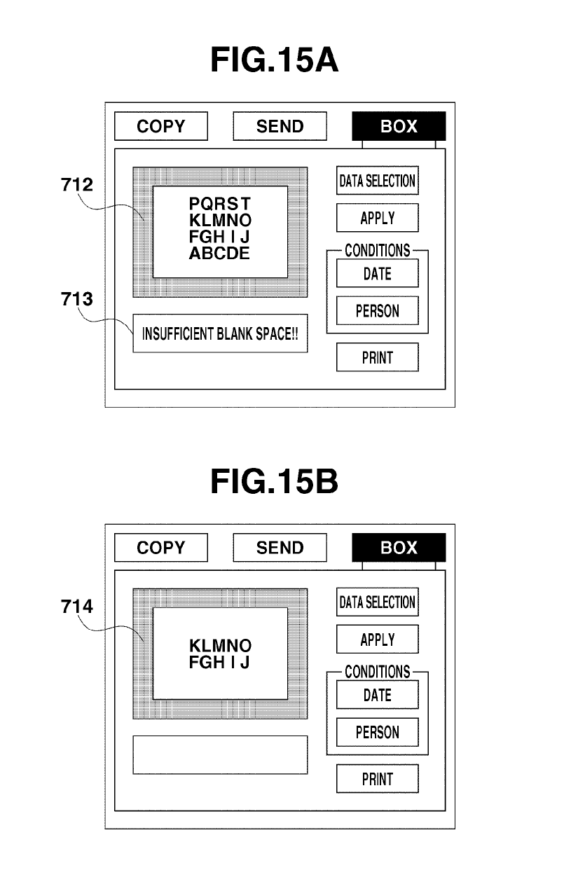

On the other hand, when the user selects the “MANUAL” button 1102 in FIG. 13, i.e., when the blank space generation unit 306 determines that the manual object data selection mode is currently selected (NO in step S1002) and the processing proceeds to step S1005. In step S1005, a user interface screen for selecting object data as illustrated in FIG. 15A appears on the operation unit 203, allowing the user to select object data to be printed.

When the user has selected object data, the processing proceeds to step S1006. In step S1006, the blank space generation unit 306 renders the object data selected by the user to generate bitmap data.

A display window 712 of the screen in FIG. 15A displays an image of the electronic document data after the currently selected object data has been rendered. The user can select whether each object is to be printed, by pressing each object area on the display window 712 or by setting object data selection conditions (for example, a condition about date and a condition about person).

When the insufficient blank space information has been received from the blank space determination unit 305 based on the total occupancy rate of the currently selected object data, a warning message appears in a message window 713 in FIG. 15A. The displayed warning message notifies the user of the fact that the occupancy rate of the currently selected object data is larger than the user-desired threshold value (in other words, the desired amount of blank space has not been obtained).

A display window 714 in FIG. 15B displays an exemplary image of the electronic document data displayed as the user selects object data to be printed. When the user deselects the objects “ABCDE” and “PQRST” out of objects displayed in FIG. 15A, only the currently selected objects “FGHIJ” and “KLMNO” are displayed as illustrated in FIG. 15B.

After the user has selected objects to be printed in this way, when the occupancy rate of the object data to be printed becomes equal to or smaller than the user-desired threshold value (in other words, the desired amount of blank space has been obtained), the warning message displayed in FIG. 15A disappears. Then, when the user presses the PRINT button, the object data selected to be printed is printed out.

As mentioned above, in the second exemplary embodiment, when the total occupancy rate of object data is equal to or lager than the predetermined threshold value, processing for reducing the amount of objects to be printed is performed. Although object data is automatically selected based on the date information in step S1003, object selection is not limited thereto but may be based on other tag information.

As mentioned above, by selecting object data to be printed so that the user-desired amount of blank space is constantly provided, the document can be printed out with a sufficient amount of blank space without changing the paper size or reducing the layout.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-278955 filed Dec. 8, 2009, which is hereby incorporated by reference herein in its entirety.

What is claimed is:

1. An image processing apparatus for generating print data used for printing objects to be printed contained in an electronic document to obtain a printed material, the image processing apparatus comprising:
a setting unit configured to set a threshold value used for determining whether the printed material provides a sufficient amount of space not having the objects laid out therein;
a determination unit configured to determine whether an occupancy rate of the objects on the printed material is larger than the set threshold value;
a changing unit configured to perform, in a case where the occupancy rate is determined to be larger than the threshold value by the determination unit, processing for changing to the objects to reduce the occupancy rate thereof; and
a print data generation unit configured to generate print data based on the objects that have been changed by the changing unit.

2. The image processing apparatus according to claim 1, wherein the setting unit sets the threshold value based on a user's instruction.

3. The image processing apparatus according to claim 1, wherein, when printing of the objects to be printed are instructed, the determination unit determines whether the occupancy rate of the objects to be printed is larger than the threshold value.

4. The image processing apparatus according to claim 1, wherein the processing performed by the changing unit is processing for reducing the size of the objects to be printed.

5. The image processing apparatus according to claim 1, wherein the processing performed by the changing unit is processing for changing the size of a paper in which the objects to be printed are printed.

6. The image processing apparatus according to claim 1, wherein the changing unit further determines the layout of the objects that have been changed to reduce the occupancy rate thereof, based on the position of the oldest object out of the objects to be printed.

7. The image processing apparatus according to claim 1, wherein the processing performed by the changing unit is processing for reducing the amount of objects to be printed.

8. The image processing apparatus according to claim 7, wherein the processing for reducing the amount of objects to be printed is performed based on tag information of the objects added thereto.

9. The image processing apparatus according to claim 7, wherein the processing for reducing the amount of objects to be printed is performed based on a user's instruction.

10. An image processing method for generating print data used for printing objects to be printed contained in an electronic document to obtain a printed material, the image processing method comprising:
setting a threshold value used for determining whether the printed material provides a sufficient amount of space not having the objects laid out therein;
determining whether an occupancy rate of the objects on the printed material is larger than the set threshold value;
performing, in a case where the occupancy rate is determined to be larger than the threshold value, processing for changing to the objects to reduce the occupancy rate thereof; and
generating print data based on the objects that have been changed.

11. A non-transitory computer-readable storage medium storing a computer program for causing a microprocessor to execute processing for generating print data used for printing objects to be printed contained in an electronic document to obtain a printed material, the computer program causing the microprocessor to operate as:
a setting unit for setting a threshold value used for determining whether the printed material provides a sufficient amount of space not having the objects laid out therein;
a determination unit for determine whether an occupancy rate of the objects on the printed material is larger than the set threshold value;
a changing unit for performing, in a case where the occupancy rate is determined to be larger than the threshold value by the determination unit, processing for changing to the objects to reduce the occupancy rate thereof; and
a print data generation unit for generating print data based on the objects that have been changed by the changing method.
